(19) United States
(12) Patent Application Publication
(10) Pub. No.: US 2018/0297036 A1
(43) Pub. Date: Oct. 18, 2018

(54) BEAD MADE OF A FUSED PRODUCT

(71) Applicant: SAINT-GOBAIN CENTRE DE RECHERCHES ET D'ETUDES EUROPEEN, Courbevoie (FR)

(72) Inventors: Emmanuel NONNET, Saint-saturnin Les Avignon (FR); Yves BOUSSANT-ROUX, Montfavet (FR)

(21) Appl. No.: 15/769,165

(22) PCT Filed: Oct. 21, 2016
(86) PCT No.: PCT/EP2016/075401

§ 371 Date: Apr. 18, 2018

(30) Foreign Application Priority Data
Oct. 21, 2015 (FR) 1560020

(51) Int. Cl. B02C 17/20; C04B 35/49; C04B 35/484

(52) U.S. Cl. CPC B02C 17/20; C04B 35/49; C04B 35/484; C04B 2235/3206; C04B 2235/94; C04B 2235/3232; C04B 2235/3418; C04B 2235/96; C04B 2235/74; C04B 2235/3217

(57) ABSTRACT

A bead having a sphericity greater than or equal 0.6 and made of a fused product having the following chemical composition, in percentages by weight on the basis of the oxides and for a total of 100%: 20%≤(ZrO₂+HfO₂), with HfO₂≤2%, 5%≤SiO₂, 0%≤Al₂O₃≤20%, 8.5%≤MgO≤20%, 0.5%≤TiO₂≤20%, and oxides other than ZrO₂, HfO₂, SiO₂, Al₂O₃, MgO and TiO₂, or “other oxides”: ≤5% provided that the (ZrO₂+HfO₂)/SiO₂ weight ratio is greater than 1, and provided that Al₂O₃+TiO₂≤26% if MgO>17%.

### TECHNICAL FIELD

The present invention relates to novel beads made of a fused product, to a powder consisting of said beads to more than 90% of its weight and to the use of this powder in particular in equipment and methods for microgrinding, microdispersion in a wet medium and surface treatment, in particular by impact.

### PRIOR ART

Equipment and methods for microgrinding, microdispersion in a wet medium and surface treatment are well known, and have notably been developed in industries such as:
the mineral industry, which employs particles for fine grinding of materials that have undergone dry pregrinding by traditional methods, notably for grinding calcium carbonate, titanium oxide, gypsum, kaolin, iron ore, ores of precious metals, and generally all ores that undergo a chemical or physicochemical treatment;
manufacturers of paints, inks, dyes, magnetic varnishes, and agrochemicals, which use particles for dispersing and homogenizing various liquid and solid constituents;
the surface treatment industry, which employs particles notably for operations of cleaning of metal molds (for making bottles for example), deburring of components, descaling, preparation of a substrate ready for coating, surface finishing (for example satin finish of steel), shot peening, or also for shaping components by peen forming.

The particles used conventionally for these markets are generally of approximately spherical shape, with a size between 0.005 and 10 mm. Depending on the intended markets, they may have one or more of the following properties:
chemically inert and coloring with respect to the products treated,
impact strength,
wear resistance,
low abrasiveness for equipment, notably stirring elements and tanks, or spraying devices, and
low open porosity for easy cleaning.

Various types of particles are used in the field of grinding, notably sand with rounded grains, glass beads, in particular glass-ceramic beads, or else metal beads.

Sand with rounded grains, such as OTTAWA sand for example, is a cheap, natural product, but is unsuitable for modern grinding mills, operating under pressure and at high production rates. In fact, the sand is of low strength and low density, variable in quality and abrasive for the equipment.

Glass beads, which are widely used, have better strength, are less abrasive and are available in a wider range of sizes.

Metal beads, notably made of steel, have also been known for a long time for the aforementioned applications, but their use is still marginal because they are often insufficiently chemically inert with respect to the products treated, notably leading to contamination of mineral fillers and greying of paints, and their density is too high, necessitating special grinding mills and notably involving high energy consumption, considerable heating and high mechanical stressing of the equipment.

There are also beads made of ceramic materials, which have the advantages of better mechanical strength than glass beads, high density and excellent chemical inertness.

These beads are of the following types:
beads made of a sintered product, obtained by cold shaping of a ceramic powder followed by consolidation by baking at high temperature, and
beads made of a fused product, generally obtained by melting a charge of raw materials, conversion of the molten material to beads, and solidification of the latter.

The sintered products are obtained by mixing suitable raw materials and then raw shaping of this mixture and baking the resultant raw article at a temperature and for a time sufficient to achieve sintering of this raw article.

In contrast to sintered products, fused products most often comprise an intergranular vitreous phase bonding the crystalline grains together. The problems posed by sintered products and by fused products, and the technical solutions adopted for solving them, are therefore generally different. Therefore a composition developed for making a sintered product is not a priori usable as it is for making a fused product, and vice versa.

The vast majority of beads made of a fused product used in the aforementioned applications have a composition of the zirconia-silica type (ZrO₂—SiO₂) where the zirconia is crystalline in the monoclinic form and/or partially stabilized (with suitable additives), and where the silica, as well as some of any additives if present, form a matrix binding the zirconia crystals.

These beads made of a fused product offer optimal properties for grinding, namely good mechanical strength, high density, they are highly chemically inert and are of low abrasiveness with respect to the grinding equipment.

Beads made of a fused product based on zirconia and the use thereof for grinding and dispersion are described for example in FR 2 320 276 and EP 0 662 461. These documents thus describe the influence of SiO₂, Al₂O₃, MgO, CaO, Y₂O₃, CeO₂, and Na₂O on the main properties of the resultant beads, notably on the properties of crushing resistance and abrasion resistance.

Although the beads made of a fused product of the prior art are of good quality, industry still has a need for products of even higher quality. In fact, grinding conditions are becoming more and more demanding.

In particular, there is a need for novel beads made of a fused product that have good wear resistance.

One aim of the invention is to meet this need, at least partially.

### SUMMARY OF THE INVENTION

The invention relates to a bead made of a fused product having the following chemical composition, in percentages by weight based on the oxides and for a total of 100%:
20%≤(ZrO₂+HfO₂), with HfO₂≤2%,
5%≤SiO₂, preferably 10%≤SiO₂,
0%≤Al₂O₃≤20%,
8.5%≤MgO≤20%,
0.5%≤TiO₂≤20%, and
oxides other than ZrO₂, HfO₂, SiO₂, Al₂O₃, MgO and TiO₂, or “other oxides”: ≤5%
   provided that the weight ratio (ZrO₂+HfO₂)/SiO₂ is greater than 1, and
   provided that Al₂O₃+TiO₂≤26% if MgO>17%.

As will be seen in more detail in the rest of the description, the inventors discovered, unexpectedly, that this combination of features improves the properties of wear resistance.

In a particular embodiment, the invention relates to a bead made of a fused product having the following chemical composition, in percentages by weight based on the oxides and for a total of 100%:
20%≤(ZrO₂+HfO₂), with HfO₂≤2%,
5%≤SiO₂,
0%≤Al₂O₃,
8.5%≤MgO
0.5%≤TiO₂, and
oxides other than ZrO₂, HfO₂, SiO₂, Al₂O₃, MgO and TiO₂, or “other oxides”: ≤5%
   provided that ZrO₂+HfO₂+SiO₂≥80% and that the weight ratio (ZrO₂+HfO₂)/SiO₂ is greater than 1.

A bead according to the invention may also have one or more of the following optional features, in all the possible combinations:
The ZrO₂ content, in percentage by weight based on the oxides, is greater than or equal to 30%, preferably greater than or equal to 35%, preferably greater than or equal to 38% and/or less than or equal to 60%, preferably less than or equal to 55%, preferably less than or equal to 50%, preferably less than or equal to 45%.
The SiO₂ content, in percentage by weight based on the oxides, is greater than or equal to 8%, preferably greater than or equal to 10%, preferably greater than or equal to 13%, preferably greater than or equal to 15%, preferably greater than or equal to 17% and/or less than or equal to 30%, preferably less than or equal to 27%, preferably less than or equal to 24%, preferably less than or equal to 22%.
The weight ratio (ZrO₂+HfO₂)/SiO₂ is greater than or equal to 1.3, preferably greater than or equal to 1.5, preferably greater than or equal to 1.7 and/or less than or equal to 5, preferably less than or equal to 4, preferably less than or equal to 3, preferably less than or equal to 2.5.
In a preferred embodiment, the Al₂O₃ content, in percentage by weight based on the oxides, is greater than or equal to 0.5%, preferably greater than or equal to 1%, preferably greater than or equal to 2%, preferably greater than or equal to 4%, preferably greater than or equal to 6%, preferably greater than or equal to 8%, preferably greater than or equal to 10% and/or less than or equal to 18%, preferably less than or equal to 16%.
The MgO content, in percentage by weight based on the oxides, is greater than or equal to 9%, preferably greater than or equal to 9.5%, preferably greater than or equal to 11%, or even greater than or equal to 13% or 15%, and/or less than or equal to 18%, preferably less than or equal to 17%, preferably less than or equal to 16%. Advantageously, the beads are of reduced porosity.
The TiO₂ content, in percentage by weight based on the oxides, is greater than or equal to 1%, preferably greater than or equal to 2%, preferably greater than or equal to 3%, preferably greater than or equal to 4%, or even greater than or equal to 5% and/or less than or equal to 18%, preferably less than or equal to 16%, preferably less than or equal to 14%, preferably less than or equal to 13%, preferably less than or equal to 12%, preferably less than or equal to 10%, or even less than or equal to 9%.
The total content of ZrO₂+HfO₂+SiO₂ is above 40%, preferably above 45%, preferably above 50%, preferably above 55%, preferably above 60%, preferably above 70%, preferably above 80% and/or less than or equal to 88%, preferably less than or equal to 85%.
The Al₂O₃/SiO₂ weight ratio is greater than or equal to 0.1, preferably greater than or equal to 0.2, preferably greater than or equal to 0.5 and/or less than or equal to 2, preferably less than or equal to 1.5, or even less than or equal to 1.0.
The MgO/SiO₂ weight ratio is greater than 0.1, preferably greater than 0.2, preferably greater than 0.3 and/or below 1, preferably below 0.95, preferably below 0.9.
The content of “other oxides”, i.e. oxides other than the aforementioned oxides, is less than or equal to 4%, preferably less than or equal to 3%, preferably less than or equal to 2% of the total weight of oxides.
The “other oxides” are only present in the form of impurities.
The content of oxides represents more than 95%, preferably more than 97%, preferably more than 99%, preferably more than 99.5%, or even more than 99.9%, and even approximately 100% of the total weight of the bead.
The total porosity of the bead is below 4.5%, or even below 4%, or even below 3%, or even below 2%.
The bead has a size below 10 mm, or even below 8 mm, or even below 6 mm, or even below 4 mm, or even below 2 mm and/or above 0.005 mm, or even above 0.01 mm, or even above 0.1 mm, or even above 0.2 mm.
The sphericity of the bead is above 0.7, preferably above 0.8, preferably above 0.85, or even above 0.9.

The invention also relates to a powder consisting of beads according to the invention to more than 90% of its weight, preferably to more than 95%, preferably to more than 99%.

The invention finally relates to the use of a powder of beads according to the invention, as a grinding agent; agent for dispersion in a wet medium; propping agent, notably for preventing closure of deep geological fractures created in the walls of an extraction well, in particular for oil; heat exchange agent, for example for a fluidized bed; or for surface treatment, in particular by impact.

### BRIEF DESCRIPTION OF THE FIGURES

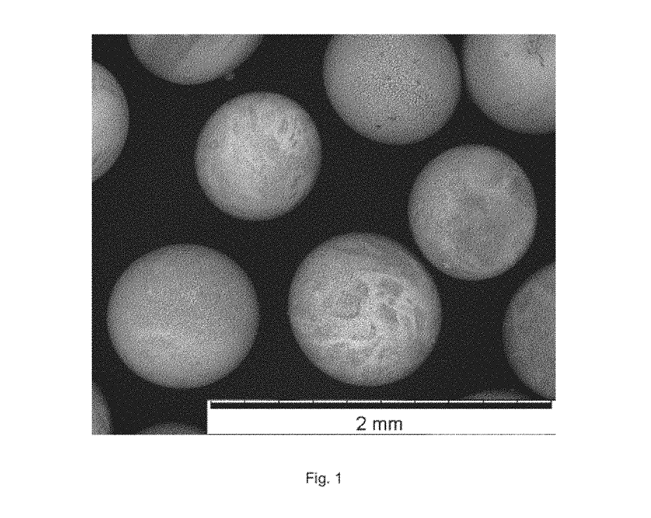

Other features and advantages of the invention will become clearer on reading the detailed description given below and on examining the appended drawing, in which FIG. 1 shows a photograph of the beads according to the invention.

### DEFINITIONS

“Particle” means an individual solid product in a powder.
“Bead” means a particle having sphericity, i.e. a ratio of its smallest to its largest diameter greater than or equal to 0.6, regardless of how this sphericity was obtained.
The “median size” of a powder of particles, generally denoted D₅₀, is the size that divides the particles of this powder into first and second populations of equal weight, these first and second populations only comprising particles having a size above or below the median size, respectively. The median size may for example be evaluated using a laser granulometer.
“Fused product” means a product obtained by solidification of a fused material by cooling.
A “fused material” is a mass which, to maintain its shape, must be contained in a vessel. A fused material is generally liquid. However, it may contain solid particles, but in an insufficient amount for them to form a structure in said mass.
“Precursor” of an oxide means a constituent that is able to supply said oxide during the manufacture of a bead according to the invention. As an example, magnesium carbonate MgCO₃ is a precursor of MgO.
“Impurities” means the inevitable constituents, introduced necessarily with the raw materials. In particular, the compounds in the group of oxides, nitrides, oxynitrides, carbides, oxycarbides, carbonitrides and metallic species of sodium and other alkali metals, iron, vanadium and chromium are impurities. As examples, we may mention CaO, Fe₂O₃, Y₂O₃ or Na₂O. Residual carbon forms part of the impurities in the composition of the products according to the invention.
When reference is made to zirconia or ZrO₂, this is to be understood as (ZrO₂+HfO₂). In fact, a small amount of HfO₂, chemically inseparable from ZrO₂ in a fusion process and having similar properties, is always present naturally in the sources of zirconia at contents generally less than or equal to 2%. Hafnium oxide is not then regarded as an impurity.

All the percentages in the present description are percentages by weight based on the oxides, unless stated otherwise.

Other features and advantages will become evident on reading the description given below.

### DETAILED DESCRIPTION

Method

According to one embodiment of the invention, a product may be made by the method comprising the following successive steps:
a) mixing raw materials to form a starting charge;
b) melting the starting charge until fused material is obtained,
c) dispersing said fused material in the form of liquid droplets and solidification of these liquid droplets in the form of solid beads,
   the raw materials being selected in step a) in such a way that the beads obtained in step c) are according to the invention.

These steps are conventional, except with respect to the composition of the starting charge, and a person skilled in the art knows how to adapt them as a function of the intended application.

A preferred embodiment of this method will now be described.

In step a), the starting charge is formed from the oxides indicated or from their precursors. Preferably, sand of natural zircon ZrSiO₄ is used, having about 66% of ZrO₂ and 33% of SiO₂, plus impurities. Supplying ZrO₂ via zircon is in fact much more economical than adding ZrO₂.

The compositions may be adjusted by adding pure oxides, mixtures of oxides or mixtures of precursors of these oxides, notably by adding ZrO₂, SiO₂, MgO, TiO₂ and Al₂O₃.

According to the invention, a person skilled in the art adjusts the composition of the starting charge so as to obtain, at the end of step c), beads according to the invention. The chemical analysis of the beads according to the invention is generally roughly identical to that of the starting charge. Furthermore, if applicable, for example to take account of the presence of volatile oxides, or to take account of the loss of SiO₂ when melting is carried out in reducing conditions, a person skilled in the art knows how to adapt the composition of the starting charge accordingly.

Preferably, no raw material other than ZrO₂+HfO₂, SiO₂, MgO, Al₂O₃, TiO₂ and their precursors is introduced deliberately in the starting charge, the other oxides present being impurities.

In step b), the starting charge is melted, preferably in an arc furnace. In fact, electric melting makes it possible to produce large amounts of beads with advantageous yields. However, all known furnaces are conceivable, such as an induction furnace or a plasma furnace, provided that they make it possible to melt the starting charge more or less completely.

In step c), a thin stream of the molten liquid is dispersed as small liquid droplets, most of which, owing to surface tension, assume an approximately spherical shape. This dispersion may be effected by blowing, notably with air and/or steam, or by any other method of atomizing a fused material, known by a person skilled in the art. A bead with a size from 0.005 to 10 mm may be produced in this way.

The resultant cooling of the dispersion leads to solidification of the liquid droplets. Solid beads according to the invention are then obtained.

Any conventional method of producing beads made of a fused product may be employed, provided that the composition of the starting charge allows beads to be obtained having a composition according to that of the beads according to the invention.

### Examples

Measurement Protocols

The following methods provide an excellent simulation of the real behavior in service in grinding applications.

To determine the so-called “planetary” wear resistance, a charge of test beads is sieved between 0.8 and 1 mm on square-mesh sieves. 20 ml (volume measured using a graduated measuring cylinder) of said test beads are weighed (weight m₀) and are placed in one of the 4 bowls coated with dense sintered alumina, with a capacity of 125 ml, of a high-speed planetary mill of the PM400 type from RETSCH. 2.2 g of silicon carbide made by Presi (having a median size D50 of 23 μm) and 40 ml of water are added to one of the bowls. The bowl is closed and set rotating (planetary motion) at 400 rev/min, reversing the sense of rotation every minute for 1.5 h. The contents of the bowl are then washed on a 100-μm sieve to remove the residual silicon carbide as well as the fragments of material due to wear during grinding. After sieving on a square-mesh sieve with mesh with side of 100 μm, the beads are then dried in a stove at 100° C. for 3 h and then weighed (weight m).

The planetary wear (PW), expressed as a percentage, is given by the following formula:

100(m₀−m)/m₀

The result PW is given in Table 1.

The results are considered to be particularly satisfactory if the beads display an improvement of planetary wear resistance (PW) of at least 10% relative to that of the example Reference 1.

To determine the so-called wear “in basic medium”. i.e. in media having a pH above 8, a charge of test beads is sieved between 0.8 and 1 mm on square-mesh sieves. An apparent volume of 1.04 liter of beads is weighed (weight m₀). The beads are then put in a horizontal mill of the Netzsch LME1 type (useful volume of 1.2 L) with eccentric disks made of steel. An aqueous suspension of calcium carbonate CaCO₃ with a pH equal to 8.2, containing 70% of dry matter, of which 40% of the grains by volume are smaller than 1 μm and whose viscosity is adjusted to a value between 100 and 250 centipoise, passes through the mill continuously, at a flow rate of 4 liters per hour. The mill is started gradually until a linear velocity at disk end of 10 m/s is reached. The mill continues in operation for a time t equal to 24 hours, and then is stopped. The beads are rinsed with water, cautiously removed from the mill and then washed and dried. They are then weighed (weight m). The wear rate V in grams/hour is determined as follows:

V=(m0−m)/t

The charge of beads is taken and supplemented with (m0−m) grams of fresh beads so as to repeat the grinding operation as many times as necessary (n times) for the cumulative grinding time to be at least 100 hours and for the difference between the wear rate calculated in step n and in step n−1 to be below 15 rel %. Typically, the total grinding time is between 100 hours and 140 hours. The wear in a basic medium is the wear rate measured for the last grinding operation n.

The percentage improvement relative to comparative example 1 is defined by the following formula: 100*(wear of the product in comparative example 1−wear of the product in question)/wear of the product in comparative example 1. The results are regarded as particularly satisfactory if the products have an improvement in wear resistance of at least 10% relative to that in comparative example 1.

The total porosity, in %, is evaluated from the following formula:

Total porosity=100·(1−(d_{beads}/d_{ground beads})), with
d_{beads}, the density for beads that have not been ground, obtained using a helium pycnometer (AccuPyc 1330 from the company Micromeritics®), according to a method based on measuring the volume of gas displaced (helium, in the present case), and
d_{ground beads} is the density measured as for d_{beads}, but on a powder resulting from grinding the beads in a dry grinder of the annular type from Aurec for 40 s and followed by sieving, only keeping for measurement the powder passing through a square-mesh sieve with mesh with side of 160 μm.

Manufacturing Protocol

A pulverulent starting charge consisting of zircon sand, alumina, magnesia and titania in the form of rutile are placed in an arc furnace of the Heroult type, in order to melt it.

The fused material is poured as a thin stream, then dispersed as beads by blowing with compressed air.

Several melting/pouring cycles are performed, adjusting the contents of titania, alumina, magnesia and zircon.

This technique provides several batches of beads of various compositions, which can then be characterized.

Results

The results obtained are summarized in the following Table 1:

TABLE 1

| | | | | | | | | | | | | Wear in |
|---|---|---|---|---|---|---|---|---|---|---|---|---|
| | ZrO₂ + | | | | | Other | (ZrO₂ + | | | Al₂O₃ + | Planetary | basic |
| | HfO₂ | SiO₂ | Al₂O₃ | MgO | TiO₂ | oxides | HfO₂)/ | Al₂O₃/ | MgO/ | TiO₂ | wear | medium |
| Ex | (%) | (%) | (%) | (%) | (%) | (%) | SiO₂ | SiO₂ | SiO₂ | (%) | (PW) (%) | (g/h) |
| 1(*) | 67 | 31 | 1 | <0.05 | <0.05 | <1 | 2.16 | 0.03 | <0.01 | <1.05 | 6 | 3.7 |
| 2 | 40.2 | 20.3 | 15.1 | 16 | 6.9 | 1.5 | 1.98 | 0.74 | 0.79 | 22.0 | 2.0 | 1.5 |
| 3 | 36.1 | 18.1 | 14.7 | 15.6 | 14.3 | 1.2 | 1.99 | 0.81 | 0.86 | 29.0 | 2.6 | |
| 4 | 61.2 | 26.4 | 1.0 | 8.9 | 1.1 | 1.4 | 2.32 | 0.04 | 0.34 | 2.1 | 3.4 | 1.4 |
| 5 | 37.8 | 19.0 | 6.2 | 17.3 | 18.5 | 1.2 | 1.99 | 0.33 | 0.91 | 24.7 | 3.3 | |
| 6(*) | 36.2 | 18.4 | 8.4 | 17.7 | 18.6 | 0.7 | 1.97 | 0.45 | 0.96 | 27.0 | 5.3 | |
| 7(*) | 29.0 | 14.1 | 19.2 | 18.3 | 18.5 | 0.9 | 2.06 | 1.36 | 1.29 | 37.7 | 6.3 | 3.5 |

(*)example not according to the invention

The beads obtained according to the invention have a total porosity less than or equal to 2%.

The beads are considered to have particularly good performance when they display, simultaneously, planetary wear less than or equal to 4%, preferably below 3%, and wear in a basic medium below 3 g/h, preferably below 2.5 g/h, preferably below 2 g/h, preferably below 1.9 g/h, preferably below 1.8 g/h, preferably below 1.7 g/h, these types of wear being measured following the above protocols.

Table 1 shows that the examples according to the invention have planetary wear two to three times lower than that of the comparative examples.

Example 1 shows that in the absence of TiO₂, or with very low contents of TiO₂, wear in a basic medium is high, typically above 2 g/h.

Example 2 according to the invention, which is the most preferred and is shown in FIG. 1, on the contrary displays wear in a basic medium well below 2 g/h, as well as planetary wear equal to 2%, i.e. well below 6%.

Example 4 shows that in the presence of 1% of TiO₂ and 1% of Al₂O₃, planetary wear is equal to 3.4%, i.e. below 4%, and wear in a basic medium is equal to 1.4 g/h.

Comparison of example 5 according to the invention and example 6 not according to the invention shows, for roughly constant MgO contents above 17%, the effect of the sum TiO₂+Al₂O₃: example 5, with said sum equal to 24.7%, shows planetary wear equal to 3.3%, in contrast to example 6, with the sum TiO₂+Al₂O₃ equal to 27%, for which planetary wear is high and equal to 5.3%. Example 7, not according to the invention, with an even higher content of TiO₂+Al₂O₃, equal to 37.7%, has high planetary wear and wear in a basic medium, equal to 6.3% and 4 g/h, respectively.

Of course, the present invention is not limited to the embodiments described, which are supplied as illustrative examples and are nonlimiting.

1. A bead having sphericity greater than or equal to 0.6 and made of a fused product having the following chemical composition, in percentages by weight based on the oxides and for a total of 100%:
20%≤(ZrO₂+HfO₂), with HfO₂≤2%,
5%≤SiO₂,
0%≤Al₂O₃≤20%,
8.5%≤MgO≤20%,
0.5%≤TiO₂≤20%, and
oxides other than ZrO₂, HfO₂, SiO₂, Al₂O₃, MgO and TiO₂, or “other oxides”: ≤5%
provided that the weight ratio (ZrO₂+HfO₂)/SiO₂ is greater than 1, and
provided that Al₂O₃+TiO₂≤26% if MgO>17%.

2. The bead as claimed in claim 1, in which MgO≤17%.

3. The bead as claimed in claim 1, in which ZrO₂+HfO₂+SiO₂≥40%.

4. The bead as claimed in claim 1, in which the weight ratio MgO/SiO₂ is greater than 0.1 and below 1.

5. The bead as claimed in claim 1, in which the Al₂O₃ content, in percentage by weight based on the oxides, is greater than or equal to 0.5%.

6. The bead as claimed in claim 5, in which the Al₂O₃ content, in percentage by weight based on the oxides, is greater than or equal to 4% and less than or equal to 18%.

7. The bead as claimed in claim 1, in which the TiO₂ content, in percentage by weight based on the oxides, is greater than or equal to 1% and less than or equal to 18%.

8. The bead as claimed in claim 7, in which the TiO₂ content, in percentage by weight based on the oxides, is greater than or equal to 4% and less than or equal to 13%.

9. The bead as claimed in claim 1, in which ZrO₂+HfO₂+SiO₂≥80%.

10. The bead as claimed in claim 1, in which the ZrO₂ content, in percentage by weight based on the oxides, is greater than or equal to 30% and less than or equal to 60%.

11. The bead as claimed in claim 1, in which the SiO₂ content, in percentage by weight based on the oxides, is greater than or equal to 10%.

12. The bead as claimed in claim 1, in which the SiO₂ content, in percentage by weight based on the oxides, is greater than or equal to 13% and less than or equal to 30%.

13. The bead as claimed in claim 1, in which the MgO content, in percentage by weight based on the oxides, is greater than or equal to 9%.

14. The bead as claimed in claim 1, in which the weight ratio ZrO₂/SiO₂ is greater than or equal to 1.3 and less than or equal to 5.

15. The bead as claimed in claim 1, in which the content of other oxides is less than or equal to 2%.

16. The bead as claimed in claim 1, having a sphericity above 0.8.

17. A powder consisting of beads as claimed in claim 1 to more than 90% of its weight.

18. The use of the powder as claimed in claim 18 as a grinding agent, agent for dispersion in a wet medium, propping agent, heat exchange agent, or for surface treatment.
